(19) United States
(12) Patent Application Publication
(10) Pub. No.: US 2009/0103696 A1
(43) Pub. Date: Apr. 23, 2009

(54) Telephone System

(76) Inventor: Scott F. Davison, Kimberly, ID (US)

Correspondence Address: HARSHAW RESEARCH, INC., 210 W. TECUMSEH STREET, OTTAWA, KS, 66067, US

(21) Appl. No.: 11/874,973

(22) Filed: Oct. 19, 2007

(51) Int. Cl. H04M 11/00; H04M 3/42

(52) U.S. Cl. 379/93.17; 379/210.02

(57) ABSTRACT

A telephone system includes a primary unit having a processor, memory device, speaker, microphone, and transmitter. The system further includes an auxiliary unit having a processor, speaker, microphone, and a receiver. The primary unit processor stores routing instructions, each one being call specific and identifying at least one of the primary or auxiliary speakers. The primary processor includes programming to route caller data to a respective one or both primary and auxiliary speakers (e.g. to ring the appropriate telephone(s)). The primary unit includes programming for transmitting call data to the appropriate respective telephone. The primary unit processor further includes time-filtering instructions such that incoming call data may be selectively sent to a voicemail unit or rejected depending on predetermined call data characteristics. Similarly, the system includes blocking instructions stored in the primary memory and utilized by the processor for blocking predetermined incoming calls.

### BACKGROUND OF THE INVENTION

The present invention relates generally to telephone screening systems and, more particularly, to a telephone system for screening incoming calls at a primary unit and routing them to predetermined auxiliary telephones.

Residents within a household are frequently disturbed at inopportune times, e.g. dinner time, by telephone calls. Sometimes, of course, the call may be coming from a person who one of the residents desires to speak with, but often the call may be from an unwelcome source such as a telemarketer, market research firm, or some other source considered by the residents to be non-essential or inconvenient at the present time.

Various devices have been proposed in the art for screening calls, including Caller-ID, audible call announcing systems, and systems that actuate predetermined ring tones upon screening a call. Although assumably effective for their intended purposes, the existing devices do not screen incoming calls and then selectively block them, allow them to ring all telephones, or to route them to a predetermined telephone auxiliary to the primary telephone. For example, the residents may want all calls to be blocked during certain hours of the day or to calls from a chosen source to ring through to a particular telephone, e.g. a child's room or an adult's home-office.

Therefore, it would be desirable to have a telephone system that screens incoming calls having a primary unit and at least one auxiliary unit that screens incoming calls for the purpose of either blocking them, allowing them to ring all auxiliary units, or to ring only a predetermined auxiliary unit. Further, it would be desirable to have a telephone system that enables a user to set up the screening process according to multiple call data characteristics such as time parameters, source of the call data, etc.

### SUMMARY OF THE INVENTION

Accordingly, a telephone system according to the present invention includes a primary unit having a processor, memory device, speaker, microphone, and transmitter. The system further includes an auxiliary unit having a processor, speaker, microphone, and a receiver. The primary unit processor stores routing instructions, each one being call specific and identifying at least one of the primary or auxiliary speakers. The primary processor includes programming to route caller data to a respective one or both primary and auxiliary speakers (e.g. to ring the appropriate telephone(s)). The primary unit includes programming for transmitting call data to the appropriate respective telephone.

The primary unit processor further includes time-filtering instructions such that incoming call data may be selectively sent to a voicemail unit or rejected depending on predetermined call data characteristics. Similarly, the system includes blocking instructions stored in the primary memory and utilized by the processor for blocking predetermined incoming calls. Both the primary and auxiliary units have respective filter input means that enable a user to direct the system to reject or terminate incoming call data.

A general object of this invention is to provide a telephone system for screening incoming calls and selecting ringing a telephone, directing incoming call data to a voicemail unit, or blocking the call data.

Another object of this invention is to provide a telephone system, as aforesaid, which includes a primary telephone unit and one or more auxiliary telephone units.

Still another object of this invention is to provide a telephone system, as aforesaid, in which the primary unit includes a processor capable of evaluating incoming call data and determining if it should be blocked, if all units should be activated, or if the call data should be routed to a particular auxiliary unit.

Yet another object of this invention is to provide a telephone system, as aforesaid, that may filter incoming call data according to time characteristics.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a telephone screening system according to the present invention;

FIG. 2 is an isolated perspective view of an auxiliary unit as in FIG. 1;

FIG. 3 is an exploded view of a primary unit as in FIG. 1;

FIG. 4 is a block diagram of the electronic components of the telephone screening system as in FIG. 1;

FIG. 5 is a flowchart illustrating the logic followed by the telephone screen system according to the present invention;

FIG. 6a is a block diagram illustrating the electronic components of one aspect of an auxiliary unit;

FIG. 6b is another block diagram illustrating the electronic components of another aspect of an auxiliary unit.

### DESCRIPTION OF THE PREFERRED EMBODIMENT

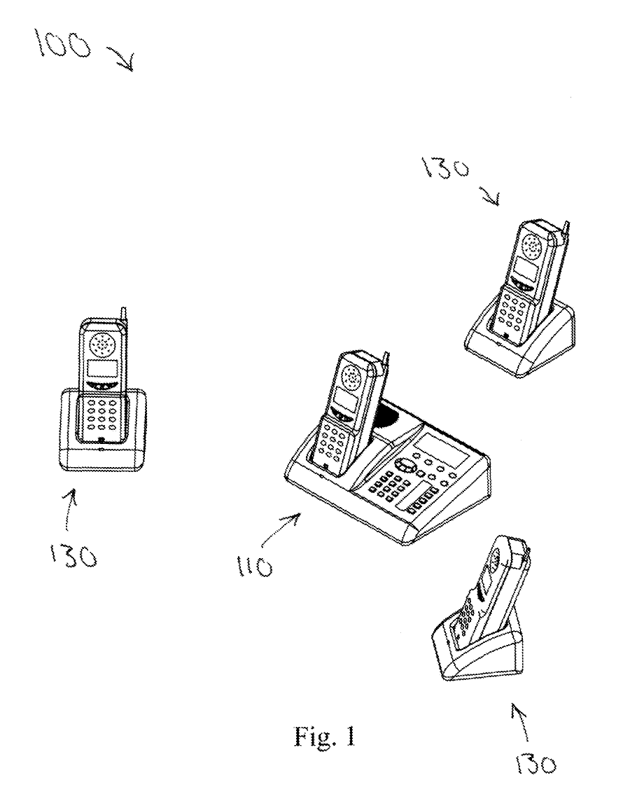

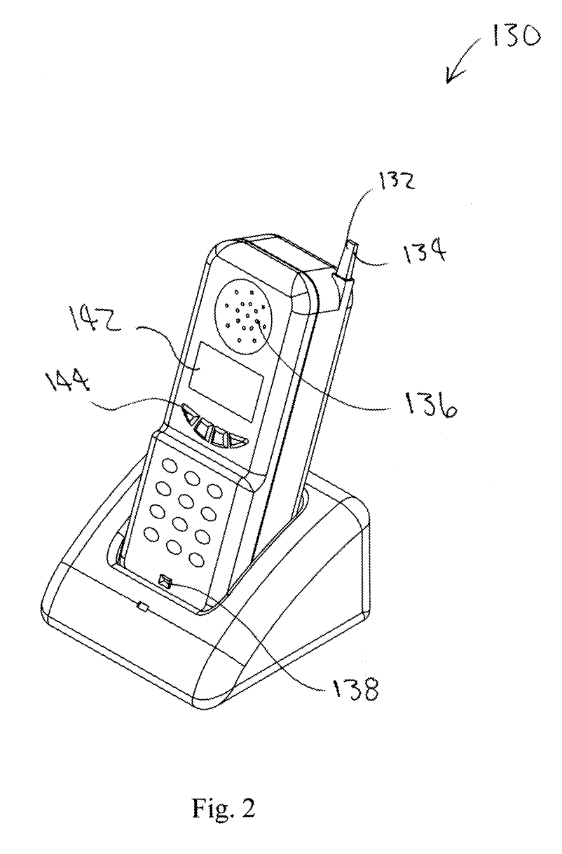

A telephone system 100 according to the present invention will now be described in detail with reference to FIGS. 1 through 6b of the accompanying drawings. More particularly, according to the current invention, telephone system 100 for use with a telecommunication network includes a primary unit 110 and at least one auxiliary unit 130 (FIG. 1).

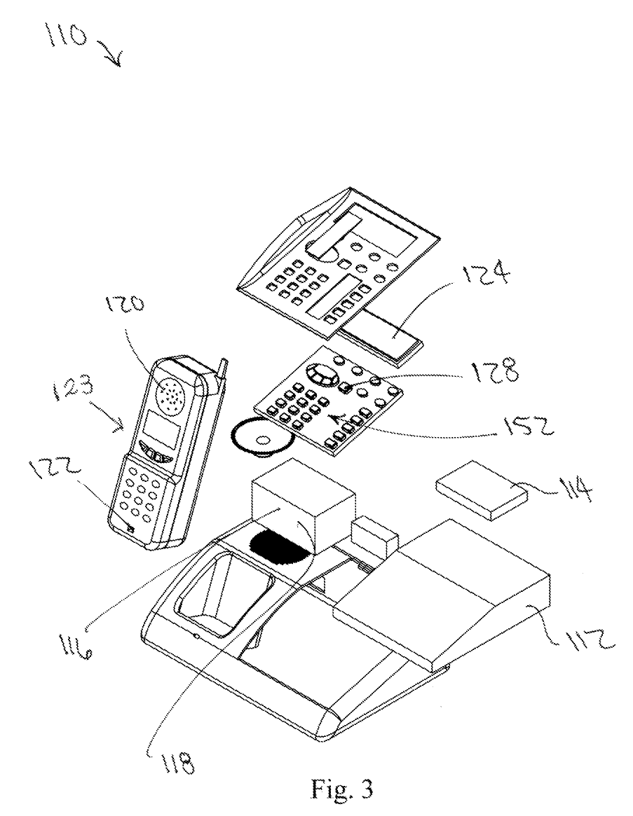

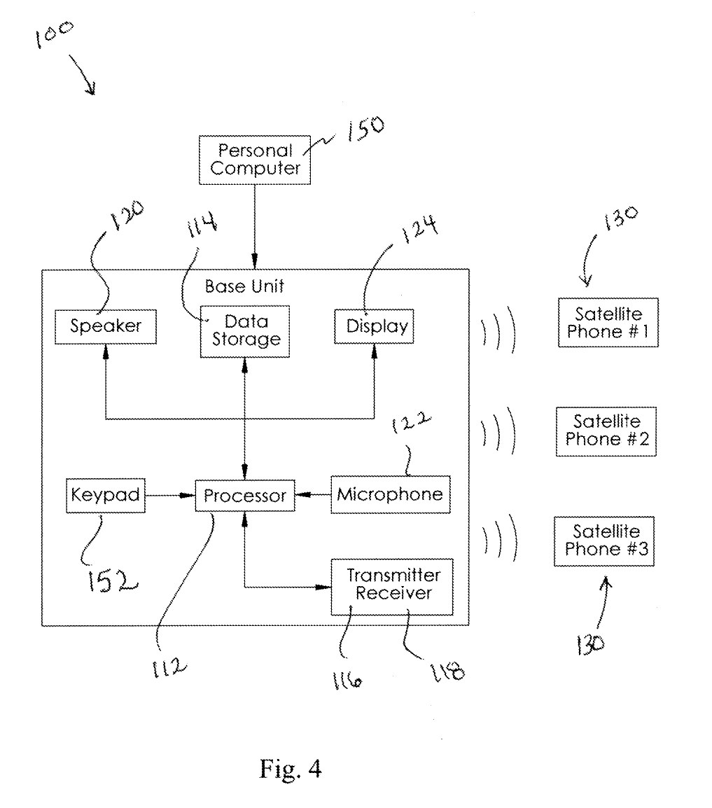

As shown in FIG. 4, the primary unit 110 includes a processor 112. The processor 112 is in data communication with the telecommunication network, such as through a fixed telephone line, a Voice over Internet Protocol (VoIP) connection, or a cellular telephone connection. A memory device 114, a transmitter 116, a receiver 118, a speaker 120, a microphone 122, a display 124, and/or an input device 126 are respectively in data communication with the processor 112. The speaker 120 and the microphone 122 may be part of a telephone handset 123 (FIGS. 1 and 3), a telephone headset, or a speaker phone, for example. The transmitter 116 and the receiver 118 may utilize wireless and/or hard-wired technology. FIG. 3 shows that a filter input 128 may additionally be in data communication with the processor 112. This button may enable a user to manually refuse a call that has been forwarded by the primary processor 112, as will be described in more detail later.

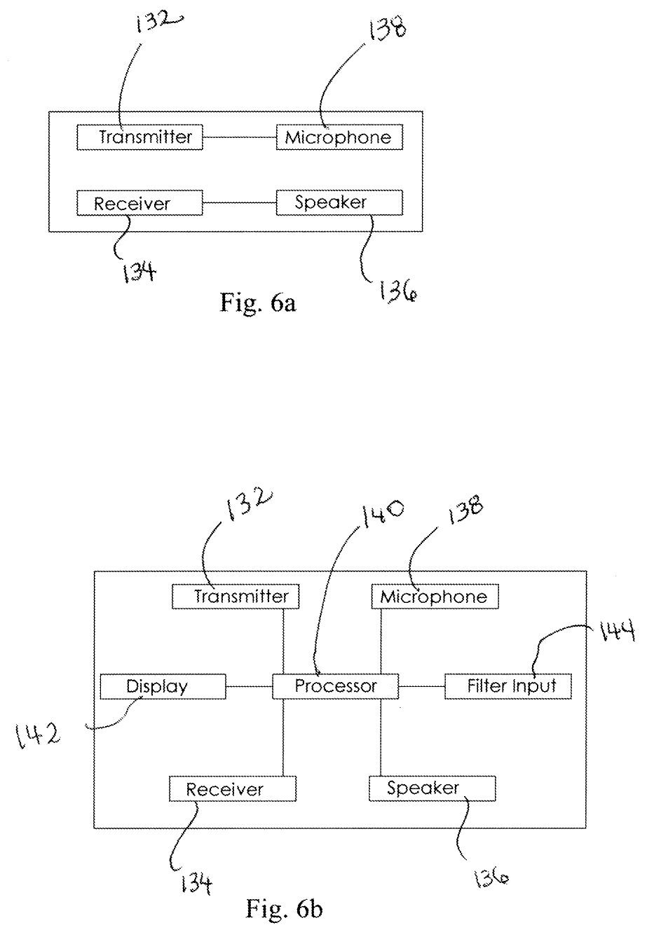

As shown in FIG. 6a, each auxiliary unit 130 may include a transmitter 132, a receiver 134, a speaker 136 in data communication with the receiver 134, and a microphone 138 in data communication with the transmitter 132. The transmitter 132 is configured to communicate with the primary unit receiver 118, and the receiver 134 is configured to communicate with the primary unit transmitter 116. As shown in FIG. 6b, each auxiliary unit 130 may additionally include a processor 140 in data communication with the speaker 136, the microphone 138, the transmitter 132, the receiver 134, a display 142, and/or a filter input 144.

It is understood that the processor, memory device, speaker, etc. associated with the primary processor may be referenced herein as a first/primary processor, first/primary memory device, first/primary speaker, and so on. Similarly, the processor, speaker, microphone associated with the auxiliary unit may be referenced herein as the second or auxiliary processor, second/auxiliary speaker, second/auxiliary unit, and so on.

Means for storing various instructions in the primary unit memory device 114 may be included. More particularly, a computer 150 may be in data communication with the primary unit processor 112 (FIG. 4), either through wireless or hard-wired technology, and/or an input device 152 (e.g., a keypad) may be in data communication with the primary unit processor (FIG. 4).

Among other instructions, the means for storing may be used to store a plurality of caller specific routing instructions, a plurality of caller specific blocking instructions, and/or time-related filtering instructions, as discussed in detail below. The plurality of caller specific routing instructions may identify the primary unit speaker 120 and/or at least one auxiliary unit speaker 136.

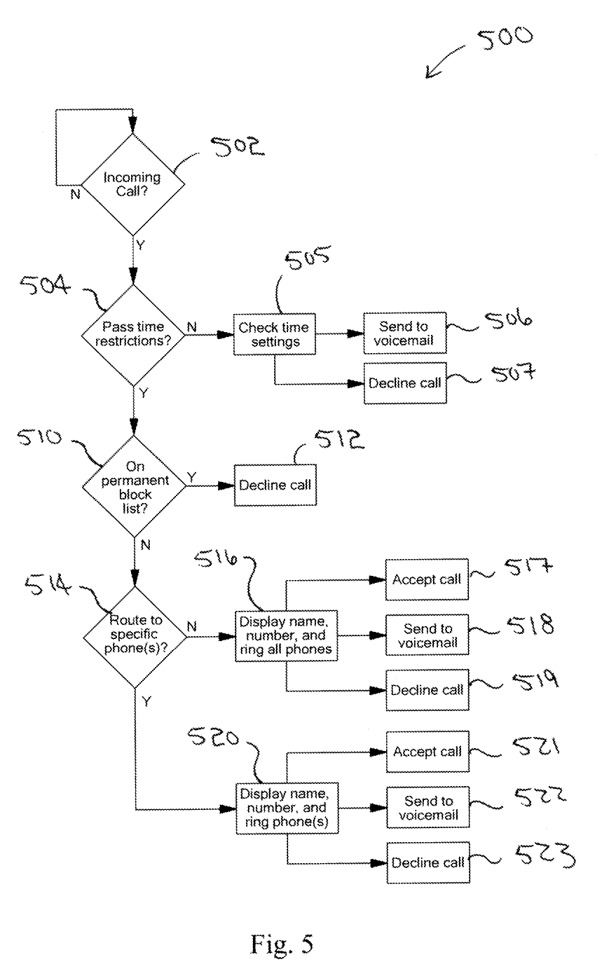

FIG. 5 shows an exemplary process 500 utilized by the system 100. At a first step 502, the primary unit processor 112 determines if there is incoming call data (i.e., an incoming telephone call) from the telecommunication network. When there is incoming call data, the process 500 proceeds to step 504.

At step 504, the primary unit processor 112 employs programming to utilize the time-related filtering instructions noted above. For example, the time-related filtering instructions may require all calls received between the hours of 10:00 p.m. and 7:00 a.m. to be directed to a voicemail device or declined. Therefore, the processor 112 would determine if the incoming call data was arriving between the hours of 10:00 p.m. and 7:00 a.m. If the incoming call data passes the time restrictions (i.e., if in the above example the incoming call data was arriving between the hours of 7:00 a.m. and 10:00 p.m.), the process 500 proceeds to step 510. If not, the process 500 proceeds to step 505.

At step 505, the primary unit processor 112 determines if there is a setting associated with the time-related filtering instructions, and the process 500 then proceeds to carry out those settings using the programming for utilizing the time-related filtering instructions. For example, if there is a setting associated with the time-related filtering instructions that instructs the processor 112 to send the call data to a voicemail device (which may either be located in the primary unit 110 or at a remote location in the telecommunication network, for example), the process 500 proceeds to step 506, where the processor 112 sends the call data to the voicemail device. Alternately, if there is a setting associated with the time-related filtering instructions that instructs the processor 112 to decline the call data (i.e., to refuse the call, or in other words, to “hang up” on the caller), the process 500 proceeds to step 507, where the processor 112 declines the call data. While in some embodiments there may be a choice between steps 506 and 507, other embodiments may directly proceed from step 504 to step 506 or step 507 without option.

At step 510, the primary unit processor 112 employs programming to utilize the caller specific blocking instructions noted above. For example, the processor 112 determines if the incoming call data is from a phone number that is included in the caller specific blocking instructions. A phone number may be included in the caller specific blocking instructions as an individual number, or all phone numbers from a specific area code may be included, for example. To determine if the incoming call data is from a phone number that is included in the caller specific blocking instructions, the processor 112 may compare caller identification data obtained from the telecommunication network with the blocking instructions, for example. If the call data is from a phone number that is included in the caller specific blocking instructions, the method 500 may proceed to step 512 where the processor 112 declines the call data (i.e., refuses the call, or in other words, “hangs up” on the caller); if not, the method 500 may continue to step 514.

At step 514, the primary unit processor 112 employs programming to utilize the caller specific routing instructions noted above. More particularly, the processor 112 determines if the incoming call data is from a phone number that is included in the caller specific routing instructions. A phone number may be included in the caller specific routing instructions as an individual number, or all phone numbers from a specific area code may be included, for example. To determine if the incoming call data is from a phone number that is included in the caller specific routing instructions, the processor 112 may compare caller identification data obtained from the telecommunication network with the routing instructions, for example. If the call data is not from a phone number that is included in the caller specific routing instructions, the method 500 may proceed to step 516; if so, the method 500 may proceed to step 520.

At step 516, the primary unit processor 112 may actuate the display 124 to present incoming call data (i.e., the identification of the caller) and the transmitter 116 to relay the incoming call data to the auxiliary units 130. The auxiliary unit processor 140 may similarly actuate the display 142 to present the incoming call data. The primary unit 110 and the auxiliary units 130 may “ring” to announce the incoming call data. Either the speakers 120, 136 may be used to ring, or additional output devices may be utilized. The method 500 then proceeds to step 517, 518, or 519, depending on user action.

If a user accepts the call data (or in other words, if a user answers the call using either the primary unit 110 or an auxiliary unit 130), the method 500 proceeds to step 517 and then terminates. If an auxiliary unit 130 is used, the transmitter 132 and the receiver 134 may communicate with the primary unit transmitter 116 and receiver 118, and the primary unit 110 may communicate with the telecommunication network.

If a user employs an input (i.e., a button) in data communication with the processor 112 or an input (i.e., a button) in data communication with a respective processor 140 to send the call data to a voicemail device (i.e., the voicemail device discussed above in relation to step 506, or a separate voicemail device specifically related to the auxiliary unit processor 140), the method 500 proceeds to step 518 and then terminates. At step 518, the processor 112 or the processor 140 sends the call data to a respective voicemail device, depending on which input were used. Alternately, a single voicemail device could be used for the primary unit 110 and all auxiliary units 130.

If a user employs a filter input 128, 144 to decline the call data, the method 500 proceeds to step 519 and then terminates. In other words, a user may manually terminate or decline a call that has otherwise passed the screening filters described above). At step 519, if the primary unit filter input 128 were used, the primary unit processor 112 utilizes programming to reject the call data (i.e., to refuse the call, or in other words, “hang up” on the caller). At step 519, if an auxiliary unit filter input 144 were used, a respective auxiliary unit processor 140 utilizes programming to reject the call data.

At step 520, the primary unit processor 112 routes the call data to the appropriate unit(s) 110, 130, in accordance with the caller specific routing instructions noted above. Notably, the routing is executed automatically, or in other words, without input from the caller. To route call data to a respective auxiliary unit 130, the primary unit processor 112 may actuate the transmitter 116 to send the call data to the appropriate auxiliary unit receiver 134. Once the call data is routed to the correct unit(s) 110, 130, the appropriate displays 124, 142 may be actuated (i.e., by the processor 112 or the processor 140) to present the incoming call data, and the appropriate unit(s) 110 may “ring” to announce the incoming call data. As noted above, either the speakers 120, 136 may be used to ring, or additional output devices may be used. The method 500 then proceeds to step 521, 522, or 523, depending on user action.

If a user accepts the call data (or in other words, if a user answers the call using either the primary unit 110 or an auxiliary unit 130), the method 500 proceeds to step 521 and then terminates. If an auxiliary unit 130 is used, the transmitter 132 and the receiver 134 may communicate with the primary unit transmitter 116 and receiver 118, and the primary unit 110 may communicate with the telecommunication network.

If a user employs an input (i.e., a button) in data communication with the processor 112 or an input (i.e., a button) in data communication with a respective processor 140 to send the call data to a voicemail device (i.e., the voicemail device discussed above in relation to step 506, or a separate voicemail device specifically related to the auxiliary unit processor 140), the method 500 proceeds to step 522 and then terminates. At step 522, the processor 112 or the processor 140 sends the call data to a respective voicemail device, depending on which input were used. Alternately, a single voicemail device could be used for the primary unit 110 and all auxiliary units 130.

If a user employs a filter input 128, 144 to decline the call data, the method 500 proceeds to step 523 and then terminates. At step 523, if the primary unit filter input 128 were used, the primary unit processor 112 utilizes programming to reject the call data (i.e., to refuse the call, or in other words, “hang up” on the caller). At step 523, if an auxiliary unit filter input 144 were used, a respective auxiliary unit processor 140 utilizes programming to reject the call data.

It is understood that while certain forms of this invention have been illustrated and described, it is not limited thereto except insofar as such limitations are included in the following claims and allowable functional equivalents thereof.

1. A telephone system, comprising:
a primary unit having:
a first processor in data communication with a telecommunication network;
a first memory device in data communication with said first processor;
a first speaker in data communication with said first processor;
a first microphone in data communication with said first processor;
a first transmitter in data communication with said first processor;
an auxiliary unit having:
a second processor;
a second speaker in data communication with said second processor;
a second microphone in data communication with said second processor;
a second receiver in data communication with said second processor;
means for storing a plurality of routing instructions in said first memory device, each said routing instruction being caller specific and identifying at least one of said first speaker and said second speaker;
wherein said first processor includes programming for utilizing said routing instructions to route call data received from said telecommunication network to at least one of said first speaker and said second speaker; and
wherein to route respective call data to said second speaker, said first processor actuates said first transmitter to send said call data to said second receiver.

2. The system of claim 1, wherein:
said system includes means for storing time-related filtering instructions in said first memory device; and
said first processor includes programming for utilizing said time-related filtering instructions to: (a) send call data having predetermined time characteristics to a voicemail device; or (b) reject call data having said predetermined time characteristics.

3. The system of claim 2, wherein:
said system includes means for storing a plurality of blocking instructions in said first memory device, each said blocking instruction being caller specific; and
said first processor includes programming for utilizing said blocking instructions to block call data received from said telecommunication network.

4. The system of claim 3, wherein:
said primary unit is in data communication with a first voicemail device; and
said auxiliary unit is in data communication with a second voicemail device.

5. The system of claim 3, wherein:
said primary unit has a first display in data communication with said first processor;
said auxiliary unit has a second display in data communication with said second processor;
said first processor includes programming for actuating said first display to present incoming call data; and
said second processor includes programming for actuating said second display to present incoming call data.

6. The system of claim 5, wherein:
said primary unit has a first filter input in data communication with said first processor;
said auxiliary unit has a second filter input in data communication with said second processor;
said first processor includes programming for rejecting call data upon actuation of said first filter input; and
said second processor includes programming for rejecting call data upon actuation of said second filter input.

7. The system of claim 1, wherein:
said primary unit has a first receiver in data communication with said first processor;
said auxiliary unit has a second transmitter in data communication with said second processor;
said second processor actuates said second transmitter to send data from said second microphone to said first receiver; and
said first processor provides data from said first receiver to said telecommunication network.

8. The system of claim 1, wherein:
said system includes means for storing a plurality of blocking instructions in said first memory device, each said blocking instruction being caller specific; and
said first processor includes programming for utilizing said blocking instructions to block call data received from said telecommunication network.

9. The system of claim 1, wherein said means for storing a plurality of routing instructions in said first memory device includes a computer in data communication with said first processor.

10. The system of claim 1, wherein said means for storing a plurality of routing instructions in said first memory device includes an input device in data communication with said first processor.

11. A telephone system for use with a telecommunication network, said system comprising:
a primary unit having:
a first processor in data communication with a telecommunication network;
a first memory device in data communication with said first processor;
a first speaker in data communication with said first processor;
a first microphone in data communication with said first processor;
a first transmitter in data communication with said first processor;
a first receiver in data communication with said first processor;
an auxiliary unit having:
a second transmitter;
a second receiver;
a second speaker in data communication with said second receiver;
a second microphone in data communication with said second transmitter;
means for storing a plurality of routing instructions in said first memory device, each said routing instruction being caller specific and identifying at least one of said first speaker and said second speaker;
wherein said first processor includes programming for utilizing said routing instructions to route call data received from said telecommunication network to at least one of said first speaker and said second speaker; and
wherein to route respective call data to said second speaker, said first processor actuates said first transmitter to send said call data to said second receiver.

12. The telephone system of claim 11, wherein:
said system includes means for storing a plurality of blocking instructions in said first memory device, each said blocking instruction being caller specific; and
said first processor includes programming for utilizing said blocking instructions to block call data received from said telecommunication network.

13. The telephone system of claim 12, wherein:
said means for storing a plurality of routing instructions in said first memory device includes at least one of: (a) a computer in data communication with said first processor, and (b) an input device in data communication with said first processor; and
said means for storing a plurality of blocking instructions in said first memory device includes at least one of: (a) a computer in data communication with said first processor, and (b) an input device in data communication with said first processor.

14. The telephone system of claim 12, wherein:
said system includes means for storing time-related filtering instructions in said first memory device; and
said first processor includes programming for utilizing said time-related filtering instructions to: (a) send call data having predetermined time characteristics to a voicemail device; or (b) reject call data having said predetermined time characteristics.

15. The telephone system of claim 14, wherein said means for storing time-related filtering instructions in said first memory device includes at least one of: (a) a computer in data communication with said first processor, and (b) an input device in data communication with said first processor.

16. The telephone system of claim 14, wherein:
said primary unit has a first display in data communication with said first processor;
said first processor includes programming for actuating said first display to present incoming call data;
said primary unit has a first filter input in data communication with said first processor; and
said first processor includes programming for rejecting call data upon actuation of said first filter input.

17. The telephone system of claim 11, wherein:
said system includes means for storing time-related filtering instructions in said first memory device; and
said first processor includes programming for utilizing said time-related filtering instructions to: (a) send call data having predetermined time characteristics to a voicemail device; or (b) reject call data having said predetermined time characteristics.

18. A telephone system for use with a telecommunication network, said system comprising:
a primary unit having:
a first processor in data communication with a telecommunication network;
a first memory device in data communication with said first processor;
a first speaker in data communication with said first processor;
a first microphone in data communication with said first processor;
a first transmitter in data communication with said first processor;
a first receiver in data communication with said first processor;
an auxiliary unit having:
a second transmitter;
a second receiver;
a second speaker in data communication with said second receiver;
a second microphone in data communication with said second transmitter;
means for storing a plurality of blocking instructions in said first memory device, each said blocking instruction being caller specific; and
wherein said first processor includes programming for utilizing said blocking instructions to block call data received from said telecommunication network.

19. The system of claim 18, wherein:
said system includes means for storing time-related filtering instructions in said first memory device; and
said first processor includes programming for utilizing said time-related filtering instructions to: (a) send call data having predetermined time characteristics to a voicemail device; or (b) reject call data having said predetermined time characteristics.

20. The system of claim 19, wherein:
said system includes means for storing a plurality of routing instructions in said first memory device, each said routing instruction being caller specific and identifying at least one of said first speaker and said second speaker;
said first processor includes programming for utilizing said routing instructions to route call data received from said telecommunication network to at least one of said first speaker and said second speaker;
to route respective call data to said second speaker, said first processor actuates said first transmitter to send said call data to said second receiver;
said means for storing a plurality of routing instructions in said first memory device includes at least one of: (a) a computer in data communication with said first processor, and (b) an input device in data communication with said first processor;
said means for storing a plurality of blocking instructions in said first memory device includes at least one of: (a) a computer in data communication with said first processor, and (b) an input device in data communication with said first processor; and
said means for storing time-related filtering instructions in said first memory device includes at least one of: (a) a computer in data communication with said first processor, and (b) an input device in data communication with said first processor.
